(19) United States
(12) Patent Application Publication
(10) Pub. No.: US 2013/0189481 A1
(43) Pub. Date: Jul. 25, 2013

(54) METHOD FOR PREPARING POROUS NANSTRUCTURED CERAMIC BILAYERS, CERAMIC BILAYERS OBTAINED BY SAID METHOD AND USES OF SAME

(71) Applicants: David Grosso, Cheptainville (FR); Christophe Sinturel, La Ferte Saint Aubin (FR); Marylene Vayer, Jargeau (FR)

(72) Inventors: David Grosso, Cheptainville (FR); Christophe Sinturel, La Ferte Saint Aubin (FR); Marylene Vayer, Jargeau (FR)

(21) Appl. No.: 13/583,067

(22) PCT Filed: Mar. 17, 2011
(86) PCT No.: PCT/FR2011/050551

§ 371 Date: Dec. 20, 2012

(30) Foreign Application Priority Data
Mar. 19, 2010 (FR) 1051976

(51) Int. Cl. C04B 35/622; C04B 38/00; B05D 3/06

(52) U.S. Cl. CPC C04B 35/622; B05D 3/067; C04B 38/0006
USPC 428/118; 427/510; 428/119; 428/304.4

(57) ABSTRACT

A method is provided for preparing porous nanostructured ceramic bilayers resting on a substrate, to the bilayers obtained by the method, and to the various uses of same, in particular in micro and nanofluidics, optics, photocatalysis and for separating and detecting analytes or molecules of interest. The method includes: 1) a first step of forming a supported polymer cavity having oriented cylindrical porosity; 2) a second step of filling and covering the polymer cavity with a solution or a dispersion of at least one ceramic precursor, optionally functionalised, in an organic solvent; 3) a third step of eliminating the polymer cavity used in step 2) by thermal treatment.

The present invention relates to a method for preparing ceramic porous thin layers having a cathedral structure, to the thin layers obtained by the implementation of this method, and also to the various applications of these thin layers.

The preparation of ceramic porous layers via a liquid route is often combined with sol-gel technology, which involves the use of a solution containing inorganic precursors having various degrees of polycondensation dissolved or dispersed in a volatile solvent. This solution is deposited on the surface of a substrate by coating methods. The layer formed by the deposition of this solution is then subjected to the evaporation of the solvent, which leads to the gradual concentration of the inorganic precursors and the formation of a solid layer on the surface of the substrate. The thickness of the final layer may be controlled by adjusting the process parameters and the dilution of the initial solution. The porosity is governed by the size and the natural stacking of the inorganic species. A second, better controlled porosity can be introduced by combining pore-forming agents (molecules, surfactant or amphiphilic micelles, latex beads, etc.) with the inorganic precursors in the solution. These species are deposited at the same time as the inorganic precursors which then form a continuous three-dimensional network around the pore-forming agents. The latter are stacked randomly, or in a 3D organized structure, usually cubic, by convective and capillary phenomena generated by the evaporation of the solvent. After consolidation of the inorganic network and removal of the pore-forming agents, the film is formed of a 3D porous network that is homogenous over the entire thickness and accessible via the interface with the air.

This preparation technique results in layers, the chemical nature of which may be extremely varied and the porosity of which may be between 0 and 60% by volume, with pore sizes ranging from 0.2 to 100 nm in diameter.

However, by using this preparation technique it is difficult to obtain thin layers having both a porosity greater than 50% by volume and a good mechanical strength. Indeed, the higher the porosity is, the more mechanically weak the network becomes. Furthermore, the interconnection between the pores is difficult to adjust because it corresponds to the opening of the inorganic network between the pore-forming agents at the weakest locations (zones for which the inorganic wall is the thinnest).

In certain cases, this porosity must be made inaccessible to its environment (often the atmosphere) in order to prevent the pollution thereof by adsorption. The sealing of this porosity by liquid deposition of a dense second layer of the same material (or of a different material) then becomes problematic since the precursors may infiltrate the porosity and modify or even occlude the latter.

Solutions that make it possible to seal very porous layers exist, however they require multi-step procedures that involve, for example, a step of partial stabilization of the porous layer, then a step of depositing a second layer that covers the first layer, a third step of removing pore-forming agents from the first layer, or else they require expensive techniques that are more difficult to carry out such as physical depositions, chemical vapor deposition (known under the acronym CVD), plasma-enhanced chemical vapor deposition (known under the acronym PECVD) or physical vapor deposition (known under the acronym PVD).

Certain authors propose methods for preparing a porous layer that consist in forming a porous polymer template at the surface of a substrate then in filling the porosity of said template with a solution of a precursor of the material that must form the porous layer, Gong. Y et al. (Chem. Mater., 2008, 20, 1203-1205) describe for example the preparation of nanoporous inorganic films according to a method that consists in preparing a porous polymer template from a polystyrene-block-poly(methyl methacrylate) (PS-b-PMMA) block copolymer in which the PS/PMMA volume fraction is 0.27 and which is applied to a silicon substrate by spin-coating. After removal of the PMMA blocks by UV irradiation, the substrate is covered with cylindrical micropillars of PS which are then used as a template for the formation of a nanoporous inorganic film of ZnO type with the aid of a solution of a precursor of ZnO, or else of TiO₂ or SiO₂ type according to a sol-gel methodology. After removal of the nanopillars of PS by heat treatment, a monolayer film is obtained having a porosity that is open to the external environment and in which the pores have a cylindrical shape and are non-communicating. Melde B. J. et al. (Chem. Mater., 2005, 17, 4743-4749) furthermore describe the preparation of silica nanostructures according to a method that consists in preparing a porous polymer template also from a PS-b-PMMA copolymer in which the PS/PMMA volume fraction is 70/30, rendered porous by removal of the PMMA blocks by UV irradiation, then in filling and mineralizing the pores of this template with tetraethoxysilane (TEOS) via vapor-phase or liquid-phase reactions. The PS template is finally removed by calcination. A layer formed of adjacent cylindrical pillars of SiO₂ is obtained. The method used for filling the pores consists in immersing the template in an alcoholic solution of TEOS for a period varying between 24 and 72 hours. This method is not satisfactory insofar as it results in a slow and incomplete filling of the pores. Furthermore, this method does not make it possible to obtain a thin layer having an isolated porosity or porosity that is not very accessible to environmental pollutants.

Currently, no method exists that makes it possible to simply, and in a minimum number of steps, attain nanostructured ceramic thin layers that have a porosity that is not, or not very, accessible to the outside and that have a pore volume greater than 50%, while remaining mechanically strong.

The inventors therefore gave themselves the objective of developing a method that makes it possible to produce such thin layers.

One subject of the present invention is therefore a method for preparing a nanostructured porous ceramic bilayer supported on a substrate, said bilayer comprising a lower layer in contact with the substrate and formed of ceramic pillars, said lower layer having a completely interconnected porosity of greater than 50% by volume, and a continuous upper ceramic layer resting on the lower layer of ceramic pillars, said upper layer having a volume porosity lower than the volume porosity of the lower layer, said method being characterized in that it comprises the following steps:

1) a first step of forming, via a liquid route, a supported polymer template having an oriented cylindrical porosity, said first step comprising the following sub steps:

i) the formation of a polymer film by application, to the surface of a substrate, of a block copolymer chosen from the copolymers formed from polystyrene (PS) and sacrificial blocks (SBs) chosen from polyoxyethylene (PEO), polylactide (PLA) and polybutadiene (PB) blocks and wherein the volume fraction of SBs varies from 0.20 to 0.40, in solution in an organic solvent;

ii) the orientation of the sacrificial blocks along an axis substantially perpendicular to the surface of the substrate, by exposure of said polymer film to a heat treatment or to organic solvent vapors;

iii) the immobilization of said polymer film on the surface of the substrate and the partial crosslinking of the PS blocks, by ultraviolet (UV) irradiation;

iv) the selective extraction of the sacrificial blocks, in order to obtain said supported polymer template;

2) a second step of filling and covering said polymer template with a solution or a dispersion of at least one, optionally functionalized, ceramic precursor in an organic solvent;

3) a third step of removing the polymer template used in step 2), by heat treatment at a temperature above the thermal decomposition temperature of the polymer and below the structural degradation temperature of the ceramic, for a time greater than the time needed for the thermal decomposition of the polymer, in order to obtain said supported nanostructured porous ceramic bilayer,

The method in accordance with the invention makes it possible to attain nanostructured porous ceramic thin bilayers having the following features:
a lower layer having a porosity greater than 50% by volume;
a lower layer having pores that are large and homogeneous in size and that have no restriction of communication with one another;
a lower layer having an isolated porosity or porosity that is not very accessible to environmental pollutants (presence of an upper layer of higher density (lower porosity and smaller pore size than the lower layer having a porosity of greater than 50% by volume); the porous network of the lower layer is therefore protected mechanically and against external pollution by the presence of the upper layer;
an organization of the porous network al lowing a better mechanical stability of the porous lower layer, while respecting the preceding features.

The method for preparing these bilayers also possesses the following advantages:
it is possible to control the chemical nature and the intrinsic structure of the porous ceramic making up the ceramic bilayer,
it is possible to control the height of the ceramic pillars and the thickness of the upper ceramic layer (roof) in a single step,
it is possible, as a function of the template used, to control the diameter of the pillars between 5 and 50 nm approximately with a maximum deviation of 5%,
it is possible to control the mean distance separating the center of two adjacent pillars from 10 to 100 nm approximately as a function of the template used with a maximum deviation of 5%,
it results in a ceramic bilayer having a very high inter-pillar porosity with no restriction (maximum interconnection), while having a good mechanical strength,
it is easy to implement and not very expensive,
it can be combined with other chemical or physical methods for structuring layers (self-assembly, supramolecular template, lithography),

Among the block copolymers that can be used according to the invention, polymers formed of PS blocks and of PLA blocks are preferred.

The molecular weight of the block copolymers preferably varies from 5 000 to 500 000 g.mol⁻¹ and more preferably from 15 000 to 250 000 g.mol⁻¹.

Among the block copolymers that can be used in accordance with the method of the invention, PS-PLA copolymers in which the volume fraction of PLA varies from 0.20 to 0.40 and the molecular weight of which varies from 15 000 to 250 000 g.mol⁻¹ are very particularly preferred.

The organic solvent of the solution of block copolymers may be chosen from tetrahydrofuran (THF), chlorobenzene, propanol, acetone, benzene and mixtures thereof.

The amount of copolymer dissolved in this organic solvent preferably varies from 1 to 500 g/l , and more preferably still from 20 to 100 g/l.

The deposition of the solution of copolymer onto the surface of the substrate is preferably earned out by spin-coating, at a speed of 200 to 4000 revolutions per minute (rpm) approximately, for a time that varies from 5 to 600 seconds approximately. According to one particularly preferred embodiment of the invention, the deposition of the solution of copolymers is carried out at 300 rpm for 5 seconds then at 2000 rpm for 40 seconds.

The nature of the substrate on which the polymer template is formed is not critical as long as it comprises a substantially flat surface suitable for allowing the adhesion and the immobilization of the block copolymer by UV irradiation. Among the various substrates that can be used in accordance with the method of the invention, mention may especially be made of the following substrates: silicon, SiO₂, polydimethylsiloxane (PDMS), indium tin oxide (ITO, or tin-doped indium oxide), fluoride tin oxide (FTO or tin-doped fluoride oxide), platinum, gold, steels, carbon, polycarbonate, polythiophene, etc.

According to one preferred embodiment of the method in accordance with the invention, before their use, the substrates are first subjected to a treatment that makes it possible to render their surface active with respect to the grafting of the PS blocks. This treatment may, for example, be carried out by immersion of the substrate, preferably in darkness, in an acid solution, such as for example a mixture of hydrofluoric acid (HF) and of hydrochloric acid (HCl) in water for a time of 5 to 30 minutes approximately, then in an oxidizing solution, consisting, for example, of a mixture of ammonium hydroxide (NM₄OH) and of hydrogen peroxide (H₂O₂) in water, for a time of 5 to 30 minutes approximately.

When the sacrificial blocks are oriented by heat treatment, the polymer film is preferably brought to a temperature of 50 to 250° C. for a time of 30 to 600 minutes.

When the sacrificial blocks are oriented by exposure of the polymer film to organic solvent vapors, said film is preferably brought into contact with the vapors of an organic solvent chosen from tetrahydrofuran, chlorobenzene, isopropanol, benzene, trichloroethylene and 1,4-dioxane. The exposure of the polymer film to the solvent vapors is preferably carried out for a time that varies from 30 to 600 minutes.

This orientation substep gives rise to a structural reorganization of the polymer film in order to orient the longitudinal axis of the cylindrical domains of the sacrificial blocks substantially perpendicular to the plane of the substrate.

The UV irradiation during the third substep of step 1) is preferably carried out by exposing the polymer film to radiation having a wavelength that varies from 315 to 400 nm approximately, and more preferably still to a wavelength of 365-370 nm approximately. The irradiation time preferably varies from 15 to 60 minutes, at a power of 5 to 100 W.

The method used for selectively extracting the sacrificial blocks during step iv) depends on their chemical nature. Thus, when the sacrificial blocks are PEO or PLA blocks, the extraction is preferably carried out by hydrolysis and when the sacrificial blocks are PB blocks, the extraction is preferably carried out by ozonolysis. When the selective extraction of the sacrificial, blocks is carried out by hydrolysis, said hydrolysis is preferably carried out in an alkaline medium, at pH values preferably between 10 and 14.

When the sacrificial blocks are PLA blocks, the hydrolysis may, for example, be carried out by immersing the substrate to which the polymer film adheres in a basic solution, preferably in a 0.5 mol/L solution of sodium hydroxide in a 40/60 methanol/water mixture.

The ceramic precursors that can be used during the second step of the method are preferably chosen from metal salts, organometallic salts, organic metals, ceramic clusters and ceramic nanoparticles, and mixtures thereof. Among these precursors, mention may in particular be made of tetraethyl orthosilicate, methyltriethyl orthosilicate, titanium chloride, titanium isopropoxide, aluminum nitrate, zirconium chloride, zirconium acetate, iron oxalate, anatase TiO₂ nanoparticles, etc.

The solvent that can be used for dissolving or dispersing the ceramic precursory s) during step 2) is a volatile organic or aqueous solvent, in which the polymer is insoluble or weakly soluble.

For the purposes of the present invention, the expression “volatile solvent” is understood to mean a solvent that has the ability to evaporate under the deposition conditions used during the second step of the method in accordance with the invention, i.e. that is volatile at a temperature above its melting point and at a partial pressure below its saturation vapor pressure at said temperature.

According to one preferred embodiment of the invention the volatile solvent is preferably chosen from water, lower alcohols such as methanol, ethanol or propanol, acetone, ethylene glycol and mixtures thereof.

According to one preferred embodiment of the method in accordance with the invention, the amount of ceramic precursors represents from 0.01% to 40% by weight, and more preferably still from 0.1% to 10% by weight relative to the total weight of the solution/dispersion of precursors.

The solution/dispersion of ceramic precursors may also contain one or more pore-forming agents, the presence of which makes it possible to create porosity in the ceramic material forming the pillars of the lower layer and the upper layer.

Such a pore-forming agent may, for example, be chosen from cetyltrimethylammonium chloride, polyoxyethylene-b-polyoxypropylene (PEO-b-PPO) copolymers, polyethylene glycols, latex nanoparticles and mixtures thereof.

In this case, the amount of pore-forming agent present within the solution/dispersion of ceramic precursors preferably varies from 0.01% to 40% by weight approximately, and more preferably still from 0.1% to 20% by weight approximately relative to the total weight of the solution/dispersion of precursors.

The solution/dispersion of ceramic precursors may also contain one or more surfactants, the presence of which makes it possible to improve the penetration of the solution/dispersion of precursors into the polymer template. Such surfactants may for example be chosen from nonionic surfactants, among which mention may for example be made of polyoxyalkylenes and alkylpolyoxyalkylenes, cationic surfactants, among which mention may for example be made of cetyltrimethylammonium chloride, anionic surfactants, among which mention may for example be made of dodecyl sulfate. One particularly preferred nonionic surfactant is, for example, the copolymer of ethylene oxide and propylene oxide sold under the trade name Pluronic® F127 by the company BASF.

The amount of surfactant optionally present within the solution/dispersion of ceramic precursors preferably varies from 0.001% to 5% by weight approximately, and more preferably still from 0.01% to 1% by weight approximately relative to the total weight of the solution/dispersion of precursors.

The filling and the covering of the polymer template with the ceramic precursors are preferably carried out by liquid deposition of the solution/dispersion of ceramic precursors. The preferred deposition method is dip coating, which consists in dipping the template into the solution/dispersion of ceramic precursors and in withdrawing the latter at a constant speed. The immersion time is not critical and an instantaneous withdrawal is generally used. The withdrawal speed may vary from 0.001 to 30 mm approximately per second, and more preferably still from 0.1 to 10 mm approximately per second.

The evaporation of the volatile solvent occurs after the deposition and results in the concentration of the inorganic agents and the concentration of the pore-forming agents optionally present in said solution/dispersion.

The temperature used during the third step results in the removal of the polymer template and the mechanical consolidation of the ceramic network. According to one preferred embodiment of the method in accordance with the invention, the heat treatment of the third step is carried out at a temperature of 400 to 600° C. approximately for a time of 3 to 30 minutes approximately.

The bilayers are ready to be used directly after the heat treatment step.

It is however possible to perform an additional step of functionalizing the ceramic material with one or more functional groups, the nature of which will depend on the type of functionality that it is desired to impart to the ceramic material.

Thus, according to one particular embodiment of the invention, the method also comprises an additional step of functionalizing the ceramic material that consists in bringing the ceramic bilayer obtained at the end of the heat treatment step 3) into contact with at least one coupling agent bearing a functional group.

By way of example, these functional groups may be chosen from the following groups: perfluorinated alkanes (capable of imparting a hydrophobic character to the surface of the porous cavity), NH₂ and NH₃⁺ (basic functionality), COOH and COO⁻ (acidic or complexing functionality) or C₂F₅ (fluorophilic functionality).

These functional groups are borne by a coupling agent that ensures the grafting thereof to the ceramic material or within its porosity. The nature of the coupling agent to be used will depend on the nature of the ceramic material: thus, when the ceramic material is a silica-based material, the coupling agent is chosen from alkoxysilanes such as, for example, triethoxysilane and when the ceramic material is a material based on a transition metal oxide, the coupling agent is chosen from complexing agents of phosphonate type.

According to a first embodiment, the step of bringing the ceramic bilayer into contact with the coupling agent bearing the functional group may be carried out by immersing the ceramic bilayer in a solution of the coupling agent in an inert solvent, preferably chosen from water, ethanol, toluene, tetrahydrofuran and acetone.

Within this solution, the amount of coupling agent preferably varies from 0.5% to 5% by weight relative to the total weight of the solution.

The contact time of the bilayer with the coupling agent solution may vary from 5 min to 48 hours approximately. During this time the coupling agents diffuse all the way to the wall of the ceramic, to which they become attached by means of stable chemical bonds. The choice of the contact time makes it possible to control the degree of functionalization by the functional groups. A maximum degree of functionalization is achieved when the entire surface of the wall is covered by the coupling agent.

After withdrawal from the coupling agent solution, the ceramic bilayer thus functionalized is preferably washed by immersing in a solvent identical to the solvent of the coupling agent solution. After withdrawal, the ceramic bilayer is then preferably dried by natural evaporation of the solvent.

According to a second embodiment, this contacting step may be carried out by exposure of the ceramic bilayer to coupling agent vapors, for a time that preferably varies from 1 to 48 hours approximately.

The ceramic bilayer obtained according to the method described previously forms another subject of the invention. It is characterized in that it is in the form of a nanoporous ceramic bilayer supported by a flat substrate, said bilayer comprising:

a lower layer in contact with the substrate, formed of pillars made of ceramic material, the longitudinal axis of which is substantially perpendicular to the plane of the substrate, said pillars being substantially cylindrical and having a diameter of 5 to 50 am approximately, said layer having a porosity of greater than 50% by volume and wherein the mean distance separating the center of two adjacent pillars is from 10 to 100 nm approximately,

a continuous upper layer made of ceramic material resting on the lower layer of pillars made of ceramic material, said upper layer having a porosity of 0 to 50% by volume.

For the purposes of the present invention, the expression “substantially perpendicular” means that the longitudinal axis of the ceramic pillars of the lower layer forms an angle of 90°±40°, and preferably of 90°±25°, relative to the plane of the substrate.

This bilayer is in the form of a supported film having a thickness between 40 and 2000 nm inclusive and having a continuous porous network corresponding to the inter-pillar space, these pillars being organized in a hexagonal network and oriented substantially perpendicular to the surface of the substrate. These bilayers have a very high inter-pillar porosity, with no restriction (maximum interconnection), while having a good mechanical strength. The porous network is protected mechanically and against external pollution by the presence of the upper ceramic layer.

The thicknesses of each of the layers can be adjusted independently; they may vary from a few nanometers to a few hundred of nanometers.

According to one preferred embodiment of the invention, the thickness of the lower layer, i.e. the height of the ceramic pillars, varies from 20 to 1000 nm approximately and more preferably still from 50 to 500 nm approximately.

Also according to one preferred embodiment of the invention, the thickness of the upper layer varies from 1 to 2000 nm approximately and more preferably still from 10 to 400 nm approximately.

The porosity of the lower layer is formed by the inter-pillar space. The size of the pores typically depends on the diameter of the pillars and on the spacing thereof. The porosity of the lower layer results from the nature of the block copolymer used to form the polymer template. Specifically, the lower the volume fraction of PS, the smaller the porosity of the lower layer (and therefore the inter-pillar distance).

The size of the pores of the lower layer varies from a few nm to a few hundred nm vertically and from 5 to 100 nm horizontally (the smallest dimension corresponding to the smallest distance between 2 pillars).

The porosity of the upper layer may vary from 0 to 50% by volume, preferably from 0 to 30%. This porosity is generated by the optional presence of a pore-forming agent in the solution/dispersion of ceramic precursors used during step 2) of filling the polymer template. In this case, not only the upper ceramic layer will be porous, but also the pillars themselves forming the lower layer (intra-pillar porosity) since they result from the same solution/dispersion of ceramic precursors.

Thus, when a pore-forming agent is present in the solution/dispersion of ceramic precursors, the ceramic material forming the pillars of the lower layer and the continuous upper layer is a ceramic material comprising substantially spherical mesopores, the diameters of which vary from 2 to 30 nm approximately. In this material, the cylindrical pores may be aligned vertically or horizontally.

The nature of the ceramic material forming the bilayer will depend on the nature of the precursors used during the filling step 2).

According to one preferred embodiment, the ceramic material is a silica-based material chosen from SiO₂, SiO₂ organically modified by a silicone polymer such as for example by a polydimethylsiloxane, a composite of a silicon oxide and of a transition metal oxide chosen from ZrO₂, TiO₂, Al₂O₃, V₂O₅, Na₂O, ZnO, MgO, Y₂O₃, or else HfO₂, Eu₂O₃; or a silica-free amorphous or crystalline material chosen from ZrO₂, TiO₂, Al₂O₃, V₂O₅, Na₂O, ZnO, MgO, Y₂O₃, WO₃, SrTiO₃, MgTa₂O₆ and mixtures thereof.

According to one particular embodiment of the invention, the ceramic material is functionalized by one or more functional groups as defined previously.

Finally, another subject of the invention is the use of a ceramic bilayer in accordance with the invention and as defined previously:

in microfluidics or nanofluidics, in particular for the manufacture of capillary diffusion paths,

in optics, in particular as an optical layer having a low refractive index but a high mechanical solidity,

in photocatalysis, in particular when the ceramic material is formed of TiO₂, ZnO or ZnS,

for the separation or the detection of analytes or of molecules of interest: biology, electrochemistry, chromatography.

The present invention is illustrated by the following exemplary embodiments, to which it is not however limited.

### EXAMPLES

Raw materials used in the examples that follow:

PS-b-PLA: polystyrene-polylactide copolymer having a molecular weight of 90 000 g.mol⁻¹; in this copolymer the PS blocks represent 65% by volume relative to the total volume of the copolymer. The synthesis of the PS-b-PLA may, for example, be carried out according to the method described by Zalusky A. S. et al. JACS, 2002, 124, 12 761-12 773.

MeTEOS: methyltriethoxysilane sold by the company Aldrich;

TEOS: tetraethoxyorthosilane sold by the company Aldrich;

Pluronic® F127: block copolymer of ethylene oxide (106) and propylene oxide (70) sold by the company BASF;

TiCl₄: titanium tetrachloride;

ethanol (EtOH), hydrochloric acid (HCl), tetrahydrofuran (THF), methanol (MeOH), sodium hydroxide (NaOH): products purchased from Aldrich.

The crosslinking of the polystyrene blocks was carried out by ultraviolet (UV) radiation, in air, at a wavelength of 365 nm, with a UV device sold under the reference Biolink® BLX-E365 by the company Vilber Lourmat, by applying a power of 40 W for 1 hour, the samples to be crosslinked being placed 20 cm away from the source of UV radiation.

The bilayers obtained were photographed using a scanning electron microscope (SEM) sold under the reference S4200 by the company Hitachi, at an accelerating voltage of 5 keV.

### Example 1

### Preparation of a Porous Thin Bilayer of SiO₂ According to the Method in Accordance With the Invention

In this example, a thin bilayer comprising a porous layer of SiO₂ was prepared from a template constituted of a PS-b-PLA copolymer.

1) First step: Preparation of the PS-b-PLA template

A 20 mg/mL solution of PS-PLA in chlorobenzene was applied by spin-coating to a silicon substrate having the following dimensions: 10×10×0.5 mm. The deposition was carried out for 5 seconds at 300 revolutions per minute (rpm) then for 40 seconds at 2000 rpm.

The substrate thus covered with PS-PLA was treated with THF vapors for 4 hours, then the PS-PLA layer was crosslinked under UV.

The removal of the PLA blocks was carried out by immersing the substrate covered with the PS-PLA layer in a 0.5 mol/L solution of NaOH in a 40/60 (v/v) methanol water mixture.

A substrate covered with a PS template was obtained.

2) Second step: Filling of the template

A solution S1 containing 2 g of MeTEOS, 2 g of TEOS, 2 g of water acidified with 0.1 M HCl and 1 g of Pluronic® F127 in 50 g of EtOH was prepared.

This solution was stirred for 12 hours using a magnetic stirrer before it was used.

The substrate comprising the PS template was then immersed in this solution S1 at a speed of 3 mm.s⁻¹.

A substrate covered with the PS template, filled with the solution S1, was obtained.

3) Third step: Removal of the PS template and concentration of the ceramic precursors

The substrate covered with the PS template, filled with a solution S1, was then treated at 450° C. under an infrared (IR) lamp for 5 minutes to remove the PS template.

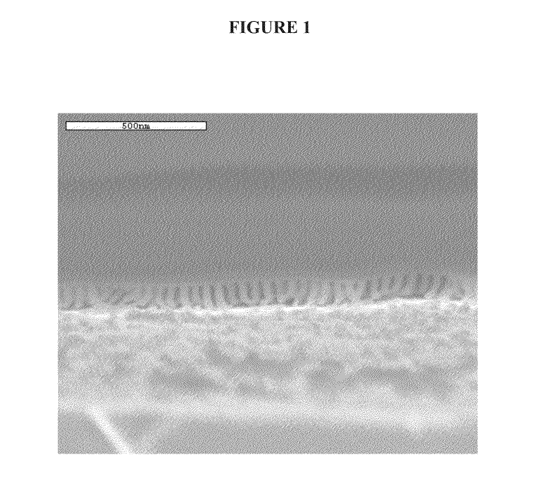

A substrate covered with a bilayer of SiO₂ was obtained, a cross-sectional image of which, taken using a scanning electron microscope (SEM), is represented in appended FIG. 1 (×72 000 magnification).

This bilayer had the following features:

thickness of the porous layer: 120 nm,

inter-pillar distance (from center to center): 55 nm,

diameter of the pillars: 30 nm,

thickness of the dense layer: 30 nm.

### Example 2

### Preparation of a Porous Thin Bilayer of Crystalline TiO₂ According to the Method in Accordance With the Invention

In this example, a thin bilayer comprising a porous layer of crystalline TiO₂ was prepared from a template constituted of a PS-PLA copolymer.

1) First step: Preparation of the PS-PLA template

The PS-PLA template was produced according to the procedure explained in detail above in example 1, first step.

A substrate covered with a PS template was obtained.

2) Second step: Filling of the template

A solution S2 containing 2 g of TiCl₄, 1 g of water and 20 g of EtOH was prepared.

This solution S2 was stirred for 30 minutes using a magnetic stirrer before it was used.

The substrate comprising the PS template was then immersed in this solution S2 at a speed of 3 mm.s⁻¹.

A substrate covered with the PS template, filled with the solution S2, was obtained.

3) Third step: Removal of the PS template and concentration of the ceramic precursors

The removal of the PS template was carried out as described above in example 1, third step.

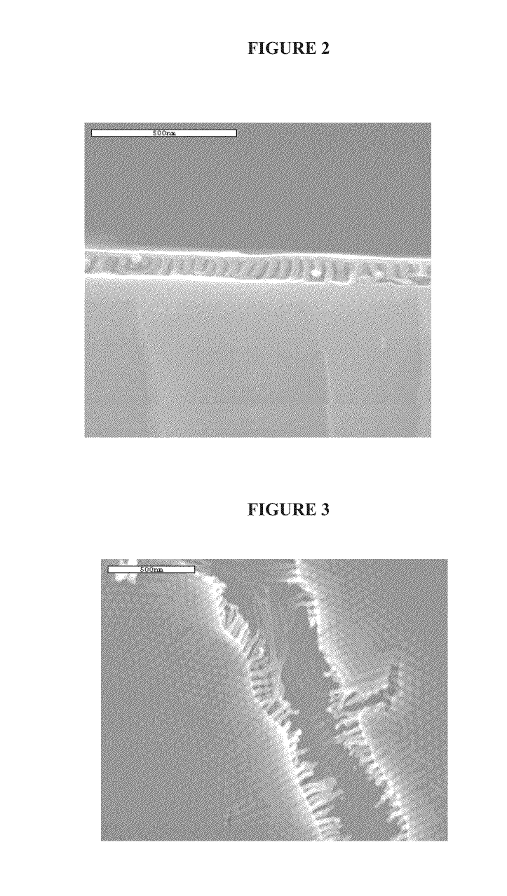

A substrate covered with a bilayer of crystalline TiO₂ was obtained, an image of which, taken using a scanning electron microscope (SEM), is represented in appended FIGS. 2 and 3 (×72 000 and ×36 000 magnifications respectively).

The image of FIG. 2 is a cross-sectional view of the bilayer.

The image of FIG. 3 is a top view of the bilayer after deliberate tearing of the bilayer so as to be able to see the internal structure thereof.

This bilayer had the following features:

thickness of the porous layer: 80 nm,

inter-pillar distance (from center to center): 55 nm,

diameter of the pillars: 30 nm,

thickness of the dense layer: 20 nm.

1. A method for preparing a nanostructured porous ceramic bilayer supported on a substrate, said bilayer having a lower layer in contact with the substrate and formed of ceramic pillars, said lower layer having a completely interconnected porosity of greater than 50% by volume, and a continuous upper ceramic layer resting on the lower layer of ceramic pillars, said upper layer having a volume porosity lower than the volume porosity of the lower layer, said method comprising the steps of:
A) a first step of forming, via a liquid route, a supported polymer template having an oriented cylindrical porosity, said first step comprising the following substeps:
i) the formation of a polymer film by application, to the surface of a substrate, of a block copolymer selected from the group consisting of the copolymers formed from polystyrene and sacrificial blocks selected from the group consisting of polyoxyethylene, polylactide and polybutadiene blocks and wherein the volume fraction of the sacrificial blocks varies from 0.20 to 0.40, in solution in an organic solvent;
ii) the orientation of the sacrificial blocks along an axis substantially perpendicular to the surface of the substrate, by exposure of said polymer film to a heat treatment or to organic solvent vapors;
iii) the immobilization of said polymer film on the surface of the substrate and the partial crosslinking of the polystyrene blocks, by ultraviolet irradiation;
iv) the selective extraction of the sacrificial blocks, in order to obtain said supported polymer template;
B) a second step of filling and covering said polymer template with at least one, optionally functionalized, ceramic precursor in solution or dispersed in a solvent;
C) a third step of removing the polymer template used in step 2), by heat treatment at a temperature above the thermal decomposition temperature of the polymer and below the structural degradation temperature of the ceramic, for a time greater than the time needed for the thermal decomposition of the polymer, in order to obtain said supported nanostructured porous ceramic bilayer.

2. The method as claimed in claim 1, wherein the block copolymers are selected from the group consisting of the polymers formed of polystyrene blocks and polylactide blocks.

3. The method as claimed in claim 1, wherein the molecular weight of the block copolymers varies from 5 000 to 500 000 g.mol⁻¹.

4. The method as claimed in claim 1, wherein the block copolymers are chosen from the polystyrene-polylactide copolymers wherein the volume fraction of polylactide varies from 0.20 to 0.40 and the molecular weight of which varies from 15 000 to 250 000 g.mol⁻¹.

5. The method as claimed in claim 1, wherein the substrate is selected from the group consisting of the following substrates: silicon, SiO₂, polydimethylsiloxane, indium tin oxide, fluoride tin oxide, platinum, gold, steels, carbon, polycarbonate and polythiophene.

6. The method as claimed in claim 1, wherein when the sacrificial blocks are oriented by heat treatment, the polymer film is brought to a temperature of 50 to 250° C. for a time of 30 to 600 minutes.

7. The method as claimed in claim 1, wherein when the sacrificial blocks are oriented by exposure of the polymer film to organic solvent vapors, said film is brought into contact with the vapors of an organic solvent selected from the group consisting of tetrahydrofuran, chlorobenzene, isopropanol, benzene, trichloroethylene and 1,4-dioxane.

8. The method as claimed in claim 1, wherein when the sacrificial blocks are polyoxyethylene or polylactide blocks, the extraction is carried out by hydrolysis and in that when the sacrificial blocks are polybutadiene blocks, the extraction is carried out by ozonolysis.

9. The method as claimed in claim, wherein the ceramic precursors that can be used during the second step of the method are selected from the group consisting of metal salts, organometallic salts, organic metals, ceramic clusters and ceramic nanoparticles, and mixtures thereof.

10. The method as claimed in claim 9, wherein the ceramic precursors are selected from the group consisting of tetraethyl orthosilicate, methyltriethyl orthosilicate, titanium chloride, titanium isopropoxide, aluminum nitrate, zirconium chloride, zirconium acetate, iron oxalate and anatase TiO₂ nanoparticles.

11. The method as claimed in claim 1, wherein the solution/dispersion of ceramic precursors also contains one or more pore-forming agents selected from the group consisting of cetyltrimethylammonium chloride, polyoxyethylene-b-polyoxypropylene copolymers, polyethylene glycols, latex nanoparticles and mixtures thereof.

12. The method as claimed in claim 1, wherein the solution/dispersion of ceramic precursors additionally contains one or more surfactants.

13. The method as claimed in claim 1, wherein the filling and covering of the polymer template with the ceramic precursors are carried out by liquid deposition of the solution/dispersion of ceramic precursors.

14. The method as claimed in claim 1, wherein the heat treatment of the third step is carried out at a temperature of 400 to 600° C. for a time of 3 to 30 minutes.

15. The method as claimed in claim 1, wherein said method also comprises an additional step of functionalizing the ceramic material that consists in bringing the ceramic bilayer obtained at the end of the heat treatment step 3) into contact with at least one coupling agent bearing a functional group.

16. The method as claimed in claim 15, wherein the functional groups are selected from the group consisting of the following groups: perfluorinated alkanes, NH₂ and NH₃⁺, COOH, COO⁻, and C₂F₅.

17. A ceramic bilayer obtained as claimed in the method as defined in claim 1, wherein said method is in the form of a nanoporous ceramic bilayer supported by a flat substrate, said bilayer comprising:
a lower layer in contact with the substrate, formed of pillars made of ceramic material, the longitudinal axis of which is substantially perpendicular to the plane of the substrate, said pillars being substantially cylindrical and having a diameter of 5 to 50 nm, said layer having a porosity of greater than 50% by volume and wherein the mean distance separating the center of two adjacent pillars is from 10 to 100 nm,
a continuous upper layer made of ceramic material resting on the lower layer of pillars made of ceramic material, said upper layer having a porosity of 0 to 50% by volume.

18. The bilayer as claimed in claim 17, wherein said bilayer is in the form of a supported film having a thickness between 40 and 2000 nm inclusive and having a continuous porous network corresponding to the inter-pillar space, these pillars being organized in a hexagonal network and oriented substantially perpendicular to the surface of the substrate.

19. A ceramic bilayer obtained as claimed in the method as defined in claim 11, wherein the ceramic material forming the pillars of the lower layer and the continuous upper layer is a ceramic material comprising substantially spherical mesopores, the diameters of which vary from 2 to 30 nm.

20. The bilayer as claimed in claim 17, wherein the ceramic material is a silica-based material selected from the group consisting of SiO₂; SiO₂ organically modified by a silicone polymer, a composite of a silicon oxide and of a transition metal oxide selected from the group consisting of ZrO₂, TiO₂, Al₂O₃, V₂O₅, Na₂O, ZnO, MgO, Y₂O₃, or else HfO₂, Eu₂O₃; or a silica-free amorphous or crystalline material chosen from ZrO₂, TiO₂, Al₂O₃, V₂O₅, Na₂O, ZnO, MgO, Y₂O₃, WO₃, SrTiO₃, MgTa₂O₆ and mixtures thereof.

21. The bilayer as claimed in claim 17, wherein the ceramic material is functionalized by one or more functional groups selected from the group consisting of: perfluorinated alkanes, NH₂ and NH₃⁺, COOH, COO⁻, and C₂F₅.

22. A method for the manufacture of capillary diffusion paths, as an optical layer, in photocatalysis or for the separation or detection of analytes or of molecules of interest, said method comprising the step of:
Employing a ceramic bilayer as defined in claim 17.
